(19) United States
(12) Patent Application Publication
(10) Pub. No.: US 2018/0194022 A1
(43) Pub. Date: Jul. 12, 2018

(54) MANUAL CUTTING TOOL

(71) Applicant: SAFRAN ELECTRICAL & POWER, Blagnac (FR)

(72) Inventors: Mickael Lazaro MARQUES, Blagnac (FR); Frederic Andre DE BIASI, Blagnac (FR)

(21) Appl. No.: 15/741,739

(22) PCT Filed: Jun. 28, 2016
(86) PCT No.: PCT/FR2016/051591

§ 371 Date: Jan. 3, 2018

(30) Foreign Application Priority Data
Jul. 9, 2015 (FR) 1556509

(51) Int. Cl. B26B 17/00; B26B 13/06

(52) U.S. Cl. CPC B26B 17/00; B26B 13/06

(57) ABSTRACT

The invention relates to a manual cutting tool (110), comprising two arms (112) hinged about an axis (X), each arm comprising a first portion (114) to enable said tool to be grasped by a user and a second cutting portion (116), said first and second portions being separated from one another by said axis, the second portions of the arms comprising cutting edges (118) that define a cross-sectional area (A) of an element to be cut, the tool being configured such that a hinge on the arms about said axis brings the cutting edges of the arms together and cuts said element. The invention is characterized in that it further comprises a member (130) for protecting the user, which is made of a transparent material, said member extending substantially in parallel with said cross-sectional area and covering same completely, and being flexible in a plane substantially perpendicular to said cross-sectional area.

### TECHNICAL FIELD

The present invention relates to a manual cutting tool, i.e. a cutting tool intended to be directly used and handled by a user. Said tool can be a pair of electrical pliers, for example.

### PRIOR ART

A cutting tool 10 of the electrical plier type, such as that which is shown in FIGS. 1 and 2, includes two arms 12 hinged about an axis X. Each arm 12 comprises a first portion 14 to enable the tool to be gripped by a user and a second cutting portion 16, the portions 14, 16 being separated from each other by the axis X.

The cutting portions 16 comprise cutting edges 18 that define a cross-sectional area A (FIG. 2) of an element 20 to be cut, which is, for example, the free end of an electrical-cable clamping ring, as shown in FIG. 3. The cross-sectional area A is flat and extends substantially perpendicularly to the axis X (FIG. 2).

Said tool is configured such that a hinged movement of the arms 12 about the axis X causes the cutting edges 18 to move towards one another and the element 20 to be cut, as shown in FIG. 4. During this cutting operation, the part that is cut and removed from the element 20 is subjected to a relatively high cutting force (force F), which results in the projection of this part, in particular when this part is small. This projection can endanger the user (projection into the eyes), but can also pollute the environment or contaminate a finished product.

The prior art includes in particular US-A1-2004/0158993, which discloses a pair of scissors provided with a member for guiding a sheet of paper when it is cut. This member is rigid and includes a slot for inserting and guiding the sheet of paper, although it does not completely cover the cutting section of the scissors.

### DISCLOSURE OF THE INVENTION

The present invention proposes an improvement to the aforementioned technology that is simple, effective and economical, and in particular allows the tool user to be protected.

To this end, the invention proposes a manual cutting tool, comprising two arms hinged about an axis, each arm comprising a first portion to enable the tool to be gripped by a user and a second cutting portion, said first and second portions being separated from one another by said axis, the second portions of the arms comprising cutting edges that define a cross-sectional area of an element to be cut, the tool being configured such that a hinged movement of the arms about said axis causes the cutting edges of the arms to move towards one another and said element to be cut, characterised in that said tool further includes a member for protecting the user, which member is made of a transparent material, said member extending substantially in parallel with said cross-sectional area and covering said area completely and being flexible in a plane substantially perpendicular to said cross-sectional area.

In the present application, a transparent material is understood to be a material through which a user can view the element to be cut. Even though it covers the aforementioned section, the protection member therefore does not hinder the visibility of the user when the element is cut.

Furthermore, flexible is understood to mean the ability of the member to elastically deform over a given amplitude. This flexibility in the plane perpendicular to the cross-sectional area prevents the member from hindering the cutting of the element when the part to be removed from this element is long or bulky. Indeed, this part to be cut and removed is intended to bear against the member and to cause it to bend so that the user can correctly position the tool with a view to making the cut.

The cutting tool according to the invention can include one or more of the following features, taken separately from each other or in combination with each other:
the member has a flat shape;
the member is formed in one piece, preferably by a plate, for example, made of plastics material such as polycarbonate;
the member includes a first part extending in parallel with said cross-sectional area, at a distance therefrom, and covering this cross-sectional area, and a second part for fastening to one of said arms;
the first part has a peripheral outline in the shape of an ogive;
the second part is configured to be detachably fastened to one of said arms;
said second part includes an engagement tab, which preferably has an elongate shape;
said tab includes two mutually inclined straight zones.

The present invention further relates to a member for protecting a user for a cutting tool as described above, characterised in that said member is formed by a plate made of transparent material, and in that said member includes a first part having a peripheral outline in the shape of an ogive and a second part comprising a tab for detachably fastening to one of the arms of the tool by inserting said tab into a cavity in this arm of the tool, the member being capable of being deformed by bending in a plane substantially perpendicular to the plane of said plate.

The present invention further relates to a method for equipping a manual cutting tool with a protection member as described above, the cutting tool comprising two arms hinged about an axis, each arm comprising a first portion to enable the tool to be gripped by a user and a second cutting portion, said first and second portions being separated from each other by said axis, the second portions of the arms comprising cutting edges that define a cross-sectional area of an element to be cut, the tool being configured such that a hinged movement of the arms about said axis causes the cutting edges of the arms to move towards one another and said element to be cut, characterised in that said method includes:
a step of inserting said tab for fastening the member into a cavity in one of the arms of the tool, such as a cavity between a rigid body of this arm and an elastic sheath surrounding said body.

### DESCRIPTION OF THE DRAWINGS

The invention will be better understood, and further details, features and advantages of the invention will become more clearly apparent, upon reading the following description, which is provided by way of a non-limiting example, and with reference to the accompanying drawings, in which:

FIG. 1 is a schematic perspective view of a cutting tool, in this case a pair of electrical pliers, according to the prior art;

FIG. 2 is another partial schematic perspective view of the tool of FIG. 1;

FIGS. 3 and 4 are schematic views of the portions and cutting edges of the tool of FIG. 1;

FIG. 4 is a partial schematic perspective view of a cutting tool according to the invention;

FIG. 5 is another partial schematic perspective view of the tool of FIG. 4 during use;

FIG. 6 is a perspective schematic view of the protection member of the tool of FIG. 4; and

FIGS. 7 and 8 are schematic views of the protection member of FIG. 4, as front and side views.

### DETAILED DESCRIPTION

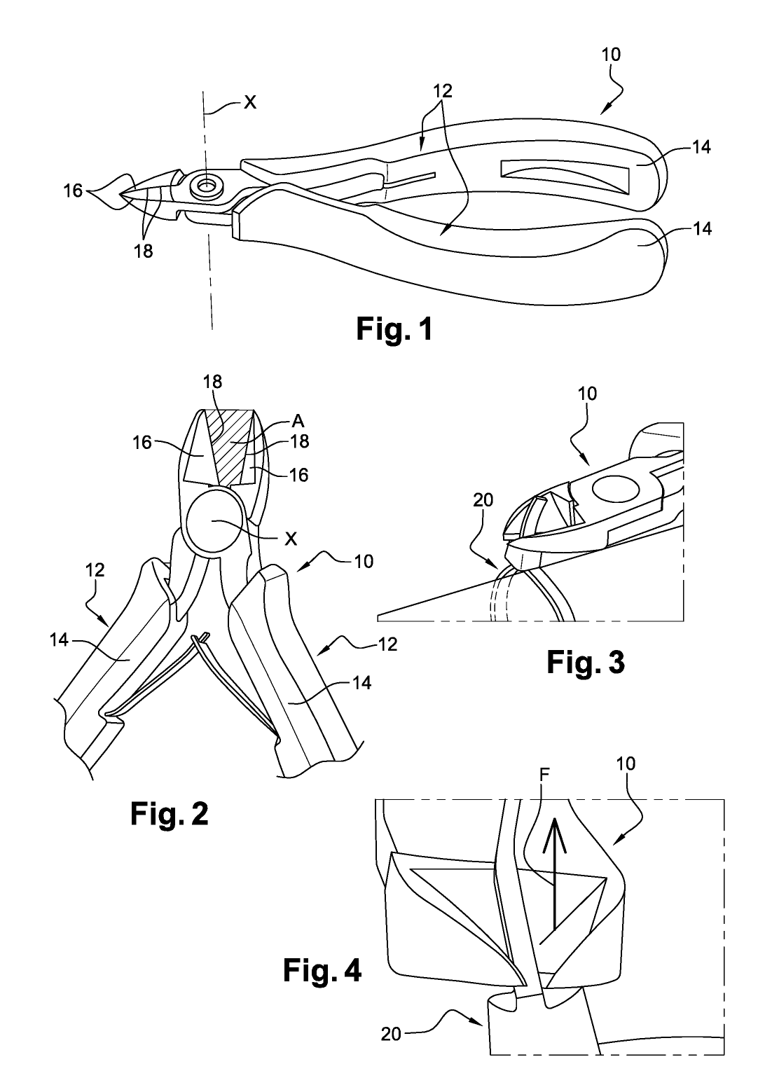

FIG. 1 to 4 have already been described and illustrate the prior art of the present invention.

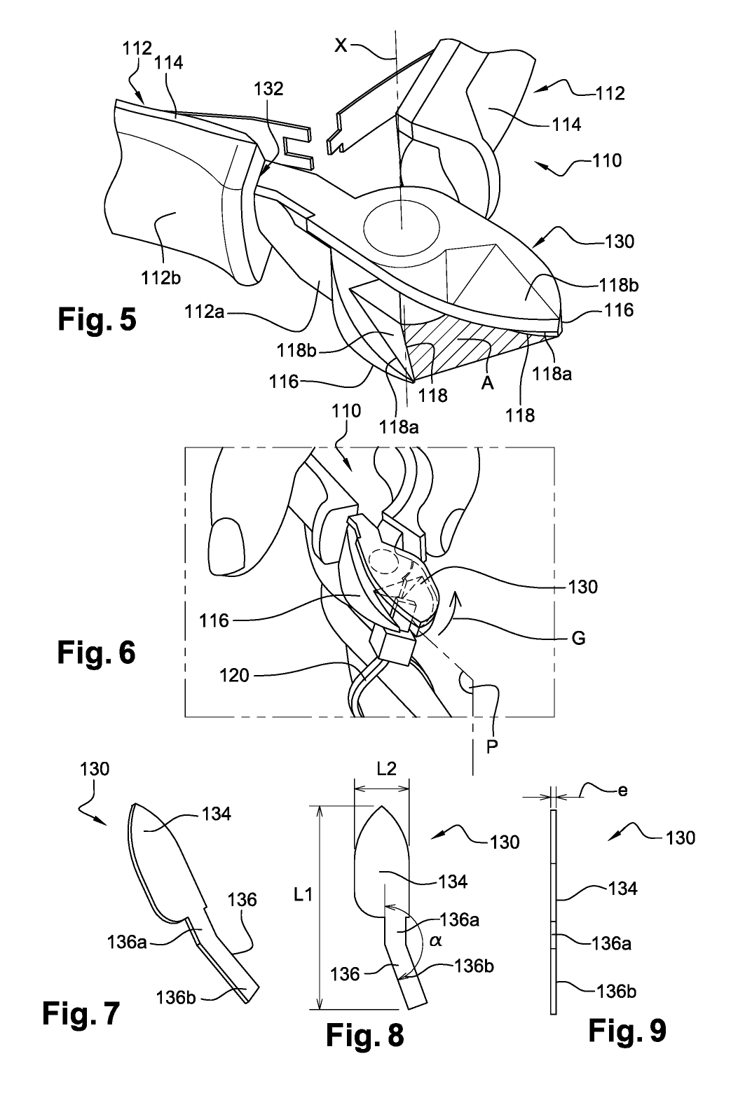

FIG. 5 to 9 show an embodiment of the invention, FIGS. 5 and 6 show a cutting tool 110 comprising a protection member 130, and FIG. 7 to 9 show this protection member 130.

The cutting tool 110 is a pair of electrical pliers in the example shown. Said tool includes two arms 112 hinged about an axis X. Each arm 112 comprises a first portion 114 to enable the tool to be gripped by a user and a second cutting portion 116, the portions 114, 116 being separated from each other by the axis X.

The cutting portions 116 comprise cutting edges 118 that define a cross-sectional area A of an element 120 to be cut, which element is, for example, the free end of an electrical-cable clamping ring, as shown in FIG. 6. The cross-sectional area A is flat and extends substantially perpendicularly to the axis X.

In the example shown, the cutting edge 118 of each portion 116 is located at the intersection of two surfaces 118a, 118b inclined at an angle of between 20 and 70° (and, for example, between 30 and 60°), a surface 118a of which is substantially parallel to the cross-sectional area A (FIG. 5).

The tool 110 is configured such that a hinged movement of the arms 112 about the axis X causes the cutting edges 118 to move towards one another and the element 120 to be cut, as shown in FIG. 6.

According to the invention, the tool 110 is provided with the protection member 130 to protect the user and in particular to prevent the cut part of the element 120 from being projected towards the user, in particular into their eyes.

The surfaces 118b of the portions 116, located on the side opposite the cross-sectional area A, are mutually inclined and are intended to be covered by the member 130, in particular when the cutting edges 118 are near one another.

The protection member 130 is made of a transparent material. This can be a plastic material, such as polycarbonate, for example, Lexan®. The member 130 extends substantially in parallel with the cross-sectional area A and at least partly covers this area. Finally, the member 130 is flexible in a plane P substantially perpendicular to the cross-sectional area A (arrow G). Its flexibility is, for example, such that an end of the member 130 can be bent by a few millimetres by elastic deformation.

In the example shown, each arm 112 includes a rigid central body 112a, in this case metallic, and a sheath 112b that covers and surrounds the body 112a and is made of an elastic material. The sheath 112b can be mounted on the body 112a after manufacture, for example, by force-fitting. By way of a variant, the sheath 112b can be mounted and fastened on the body 112a by bonding. The sheath 112b also can be manufactured in situ, for example, by overmolding.

The sheath 112b extends over the entire length of the portion 114 of each arm and stops in the vicinity of the portion 116 of this arm. Each portion 116 thus is not covered by the sheath 112b. Each portion 116 is thus formed by part of the body 112a.

The material of the sheath 112b allows elastic deformations thereof, in particular by separating the sheath from the body 112a. In particular, the end of the sheath 112b, located in the vicinity of the axis X of each arm, can be separated by elastic deformation so as to create a cavity 132 for receiving part of the member 130.

The protection member 130, which can be seen more easily in FIG. 7 to 9, in this case has a flat shape. Said member is formed in one piece, preferably by a plate, which is made of transparent plastic material, as previously explained.

The thickness e of the plate in this case is less than or equal to 3 mm and is, for example, approximately 1 mm. Said plate has a generally elongate shape and has an overall length L1 of between 30 and 50 mm and a maximum length L2 of between 10 and 20 mm.

The plate basically includes two parts 134, 136, a first part 134 extending in parallel with the cross-sectional area A, at a distance therefrom, and covering this cross-sectional area, and a second part 136 for fastening to one of the arms 112.

The first part 134 has a peripheral outline in the shape of an ogive. Said part includes a free pointed end and an opposite end that is connected to the second part 136. This second part 136 is configured to be detachedly fastened to the arm 112.

The second part 136 includes an engagement tab, which in this case is of elongate shape. This tab includes two mutually inclined straight zones 136a, 136b, in this case having an angle α of approximately 160°. A first straight zone 136a extends from the aforementioned end of the first part 134 on the side opposite the pointed end of the first part, in a direction substantially parallel to an elongation axis of the first part 134. This first straight zone 136a extends between the first part 134 and the second straight zone 136b.

The aforementioned angle a substantially corresponds to the angle between the first and second portions 114, 116 of the arm 112, so that, when the second straight zone 136b is aligned on the first portion 114 of the arm, the first straight zone 136a and the first part 134 are aligned on the second portion 116 of this arm.

In the example shown, the tab of the member 130, and in particular its second straight zone 136b, is intended to be at least partly engaged in the aforementioned cavity 132. In the assembly position, the tip of the ogive of the first part 134 of the member 130 is intended to be aligned with the tip or free end of the second portion 116 of the arm, as shown in FIG. 5.

The tool 110 can be provided with the member 130 as follows. The tab is forcibly inserted into the cavity 132. This step is performed by the user, who uses the tab to lift the sheath 112b located on the body 112a of the arm. The tab then bears against the body 112a of the arm and is rigidly held against this body by the elastic return of the sheath 112b. The member 130 is then in the position shown in FIG. 5.

The tool 130 then can be used. When the user intends to cut the ends of a clamping ring, for example (FIG. 6), he positions the tool so that the end to be cut passes through the cross-sectional area A and so that the cutting edges 118 of the tool are positioned correctly. The user can see the element 120 through the member 130, which is made of transparent material. Furthermore, if the part to be removed is of a certain length, it could, when cutting, bear against the member 130 and force it to bend in the plane P substantially perpendicular to the cross-sectional area A (arrow G). This elastic deformation by bending is also allowed so as not to hinder the cutting operation and the positioning of the tool.

The member 130 in this case is detachable and can be replaced by a new member in case of wear, for example. Other tool types can easily be provided with said member. If the tool does not include a sheath for fastening the member, it is conceivable that the member comprises fastening means such as a clamping ring. It is also conceivable that the member is permanently mounted on the tool. It is also possible for it to be retractable from a position of use to a stowed position.

1. Manual cutting tool, comprising two arms hinged about an axis (X), each arm comprising a first portion to enable the tool to be gripped by a user and a second cutting portion, said first and second portions being separated from one another by said axis, the second portions of the arms comprising cutting edges that define a cross-sectional area (A) of an element to be cut, the tool being configured such that a hinged movement of the arms about said axis causes the cutting edges of the arms to move towards one another and said element to be cut, characterised in that it further includes a member for protecting the user, which member is made of a transparent material, said member extending substantially in parallel with said cross-sectional area and covering said area completely and being flexible in a plane (P) substantially perpendicular to said cross-sectional area.

2. Cutting tool according to claim 1, wherein said member has a flat shape.

3. Cutting tool according to claim 1, wherein said member is formed in one piece, preferably by a plate, for example, made of plastics material such as polycarbonate.

4. Cutting tool according to claim 1, wherein said member includes a first part extending in parallel with said cross-sectional area (A), at a distance therefrom, and covering this cross-sectional area, and a second part for fastening to one of said arms.

5. Cutting tool according to claim 4, wherein said first part has a peripheral outline in the shape of an ogive.

6. Cutting tool according to claim 5, wherein said second part is configured to be detachably fastened to one of said arms.

7. Cutting tool according to claim 6, wherein said second part includes an engagement tab, which preferably has an elongate shape.

8. Cutting tool according to claim 7, wherein said tab includes two mutually inclined straight zones.

9. Member for protecting a user for a cutting tool according to claim 1, wherein it is formed by a plate made of transparent material, and in that it includes a first part having a peripheral outline in the shape of an ogive and a second part comprising a tab for detachably fastening to one of the arms of the tool by inserting said tab into a cavity in this arm of the tool, the member being capable of being deformed by bending in a plane (P) substantially perpendicular to the plane of said plate.

10. Method for equipping a manual cutting tool with a protection member according to claim 9, the cutting tool comprising two arms hinged about an axis (X), each arm comprising a first portion to enable the tool to be gripped by a user and a second cutting portion, said first and second portions being separated from each other by said axis, the second portions of the arms comprising cutting edges that define a cross-sectional area (A) of an element to be cut, the tool being configured such that a hinged movement of the arms about said axis causes the cutting edges of the arms to move towards one another and said element to be cut, characterised in that said method includes:
a step of inserting said tab for fastening the member into a cavity in one of the arms of the tool, such as a cavity between a rigid body of this arm and an elastic sheath surrounding said body.
